(19) United States
(12) Patent Application Publication
(10) Pub. No.: US 2020/0271051 A1
(43) Pub. Date: Aug. 27, 2020

(54) Zero Emission Onboard Charging System

(71) Applicant: James Richard Mooney, Flushing, NY (US)

(72) Inventor: James Richard Mooney, Flushing, NY (US)

(21) Appl. No.: 16/799,779

(22) Filed: Feb. 24, 2020

Related U.S. Application Data
(63) Continuation of application No. 62/804,114, filed on Feb. 25, 2019.

(51) Int. Cl. F02B 63/04; B60W 10/08; B60L 53/14; F16H 55/36

(52) U.S. Cl. CPC F02B 63/04; F16H 55/36; B60L 53/14; B60W 10/08

(57) ABSTRACT

Disclosed is a Zero Emission Onboard Charging System that charges an electric vehicle primary and secondary battery when the vehicle is being driven in full operation or at rest. The Zero Emission Onboard Charging System includes a belt driven generator configured to be installed in the vehicle, a pulley configured to the wheel to attach with a belt to the generator, a charging port configured to receive a charge from the generator, and a charge input configured to receive the charge from the charging port and to supply the charge to a primary battery and or secondary battery that powers an engine of the vehicle. Multiple belt driven generators, pulleys, inverters and batteries can be installed in configuring versions of the Zero Emission Onboard to Charging System enabling vehicles to have unlimited driving range through perpetual onboard charging capability independent of the power grid with no fuel required generating power using forward motion of the spinning wheels of the vehicle. Presently electric vehicles have zero emissions when driving, however, when they charge from the power grid emissions are transferred from the vehicle to the power plant. The Zero Emission Onboard Charging System eliminates emissions from the vehicle and ends reliance on power grid that cause emissions and pollution to generate power needed to charge EV charging stations.

### PRIORITY

This application is an Application of U.S. Patent filed in the U.S. Patent and Trademark Office on Jan. 27, 2019.

### BACKGROUND

### 1. Field of the Invention

The present invention relates generally to a Zero Emission Onboard Charging System, and more particularly, to an onboard recharging system mounted in an electric vehicle and method for recharging a primary battery or secondary battery system that uses the motion of the wheels to generate electrical charge, which charges batteries and or powers an engine of an electric vehicle when the vehicle is in full operating motion or at rest.

### 2. Description of the Related Art

Recently, the electric vehicle has increased in popularity, mainly due to the substantial increase in miles travelled on a single charge, as compared to miles per gallon generally achieved on a single tank of gasoline, in the case of gasoline-powered vehicles. This trend is likely to continue, at least in view of recent government mandates on vehicle manufacturers for higher vehicle efficiency.

As an example, the recently-introduced Chevrolet Bolt® EV (hereinafter, Bolt) is an electric vehicle that includes a 960-pound, 60 kilowatt-hour (60 kWh) lithium-ion floor-mounted battery which powers a 200 horsepower (200-hp) electric motor that has been tested as achieving a 75 mile per hour (75-mph) highway range of 190 miles, and estimated by the Environmental Protection Agency (EPA) as being capable of achieving a 238 mile range at cruising speed.

Much like the other electric vehicles on the market such as Tesla electric vehicles and those being developed by other electric vehicle manufacturers, the Bolt battery is recharged via an onboard charger that, when connected to a 110 Volt (110V) standard wall outlet (Level 1) or a 220-240 Volt (220-240V) custom home or public charging station (Level 2) supplies a charge to the battery and adds miles of range to the electric vehicle.

However, the conventional charging unit suffers from the inability to recharge the battery while the electric vehicle is in motion and suffers from the requirement to plug in the electric vehicle to the power grid or public charging stations, which is an inconvenience to the user of the electric vehicle and has caused a “range anxiety” that has restricted electric vehicle popularity.

In addition, charging stations for electric vehicles are far less prevalent in comparison to gasoline stations for gasoline-powered vehicles, which is a further inconvenience to the electric vehicle user.

Moreover, although electric vehicles are generally more efficient than gasoline powered vehicles, electric vehicles tend to have a substantially lower mileage range between charges, compared to the mileage range between fueling for the typical gasoline powered vehicle, which is another inconvenience to the user of the electric vehicle.

Moreover, the use of onboard charging systems for electric vehicles using a generator which requires fuel either diesel, gasoline, natural gas or propane requires refueling and generator emits fuel emissions which is inconvenient and bad for the environment.

As such, there is a need in the art for an Zero Emission Onboard Charging System which uses the forward spinning motion of the wheels when operating an electric vehicle that recharges vehicle while operating the electric vehicle which increases the mileage range and flexibility of the battery recharge while also eliminating the need for any type of fuel to power an onboard charging system so the electric vehicle recharges while driving and generates zero emissions from the onboard charging system. The Zero Emission Onboard Charging System utilizes a unique pulley system attached to the wheels of an electric vehicle also attached to a belt driven generator and an inverter with which the Zero Emission Onboard Charging System generates power to recharge a unique primary and secondary battery system in the electric vehicle while driving simultaneously to power being consumed by the electric vehicle while operating. The power generated from the onboard zero emission charging system while driving can be sent either directly to the primary battery system in the electric vehicle to provide extended range or to a backup battery system installed in the electric vehicle which can then be used to fully recharge the primary battery system while the electric vehicle is parked and not operating.

### SUMMARY

The present invention has been made to address at least the above-mentioned problems and/or disadvantages and to provide at least the advantages described below.

Accordingly, an aspect of the present invention is to provide a Zero Emission Onboard Charging system for an electric vehicle that does not require any fuel to power the generator, which enables a user to recharge the primary OR secondary battery(s) of the electric vehicle while the vehicle is being operated any time or any place.

Another aspect of the present invention is to provide a charging system for an electric vehicle with both a primary and secondary battery system, which significantly increases the range that the battery system can achieve on a single charge and allow for charging the primary battery from the secondary battery system, as compared to the conventional charging for electric vehicles.

Another aspect of the present invention is to provide an Zero Emission Onboard Charging System for electric vehicles, which eliminates or reduces the need to “plug-in” charge the electric vehicle at a charging station or a 110V or 220V outlet and receive the charge via the power grid while still providing the option to charge from the grid if ever desired.

According to an aspect of the present invention, a Zero Emission Onboard Charging System for a vehicle includes a belt driven generator or generators configured to be installed in the electric vehicle, a pulley or pulleys, an inverter or inverters configured to receive a charge from the generator or generators, and deliver a charge input to primary or secondary battery that powers an engine of the electric vehicle.

According to another aspect of the present invention, a Zero Emission Onboard Charging system for electric vehicles described in the preceding paragraph can be installed and utilized in all type of electric vehicles including cars, pickup trucks, SUVs, vans, semi-tractor trailers and also electric boats using pulleys attached to the propeller shaft as well as electric airplanes with pulleys attached to propeller shafts in a similar fashion delivering charge to inverters and battery systems.

According to another aspect of the present invention, a Zero Emission Onboard Charging system for a vehicle includes a belt driven generator or multiple belt driven generators attached to a pulley or pulleys connected to the wheel or wheels configured to be installed in the electric vehicle, a charge input configured to receive the charge from the generator through in inverter or inverters or a charge cable or cables, and to supply the charge to a battery or batteries that powers an engine of the electric vehicle.

### BRIEF DESCRIPTION OF THE DRAWINGS

The above and other aspects, features, and advantages of the present invention will be more apparent from the following detailed description taken in conjunction with the accompanying drawings, in which:

FIG. 1 illustrates a schematic diagram of the Onboard Zero Emission Charging System according to the present invention;

FIG. 2 illustrates a diagram displaying location of the Onboard Zero Emission Charging System installed in a Chevrolet Bolt;

FIG. 3 illustrates a diagram displaying location of the Onboard Zero Emission Charging System installed in a Tesla Model 3;

### DETAILED DESCRIPTION

Embodiments of the present invention will be described herein below with reference to the accompanying drawings. However, the embodiments of the present invention are not limited to the specific embodiments and should be construed as including all modifications, changes, equivalent devices and methods, and/or alternative embodiments of the present invention. Descriptions of well-known functions and/or configurations will be omitted for the sake of clarity and conciseness.

The terms and words used in the following description and claims are not limited to their dictionary meanings, but are merely used to enable a clear and consistent understanding of the present invention. Accordingly, it should be apparent to those skilled in the art that the following description of embodiments of the present invention is provided for illustrative purposes only and not for the purpose of limiting the present invention as defined by the appended claims and their equivalents.

Singular terms “a,” “an,” and “the” include plural references unless the context clearly dictates otherwise. For example, reference to “a component surface” includes reference to one or more of such surfaces.

The embodiments are described herein by way of illustration only and should not be construed in any way to limit the scope of the present invention. Those skilled in the art will understand that the principles of the present invention may be implemented in any suitably arranged series of components and electronic devices.

As used herein, the term “substantially” indicates that the recited characteristic, parameter, or value need not be achieved exactly, but that variations such as tolerances, measurement errors, measurement accuracy limitations and other factors known to those of ordinary skill in the art, may occur in amounts that do not preclude the effect the characteristic was intended to provide.

The expressions “have,” “may have,” “include,” and “may include” as used herein indicate the presence of corresponding features, such as numerical values, functions, operations, or parts, and do not preclude the presence of additional features. The expressions “A or B,” “at least one of A or/and B,” or “one or more of A or/and B” as used herein include all possible combinations of items enumerated with them. For example, “A or B,” “at least one of A and B,” or “at least one of A or B” indicate (1) including at least one A, (2) including at least one B, or (3) including both at least one A and at least one B.

Terms such as “first” and “second” as used herein may modify various elements regardless of an order and/or importance of the corresponding elements, and do not limit the corresponding elements. These terms may be used for the purpose of distinguishing

one element from another element. For example, a first user device and a second user device may indicate different user devices regardless of the order or importance. A first element may be referred to as a second element without departing from the scope the present invention, and similarly, a second element may be referred to as a first element.

When a first element is “operatively or communicatively coupled with/to” or “connected to” another element, such as a second element, the first element may be directly coupled with/to the second element, and there may be an intervening element, such as a third element, between the first and second elements. To the contrary, when the first element is “directly coupled with/to” or “directly connected to” the second element, there is no intervening third element between the first and second elements.

All of the terms used herein including technical or scientific terms have the same meanings as those generally understood by an ordinary skilled person in the related art unless they are defined otherwise. The terms defined in a generally used dictionary should be interpreted as having the same or similar meanings as the contextual meanings of the relevant technology and should not be interpreted as having ideal or exaggerated meanings unless they are clearly defined herein. According to circumstances, even the terms defined in this disclosure should not be interpreted as excluding the embodiments of the present invention.

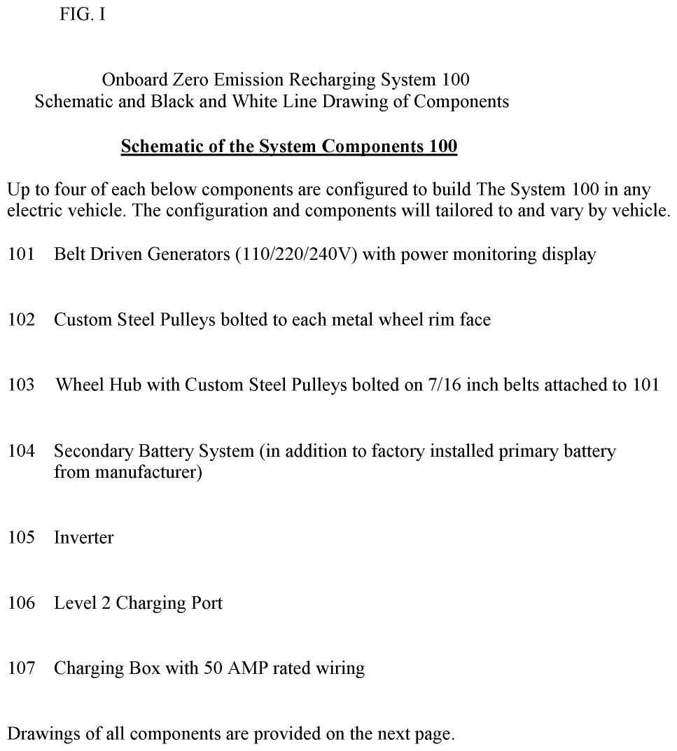

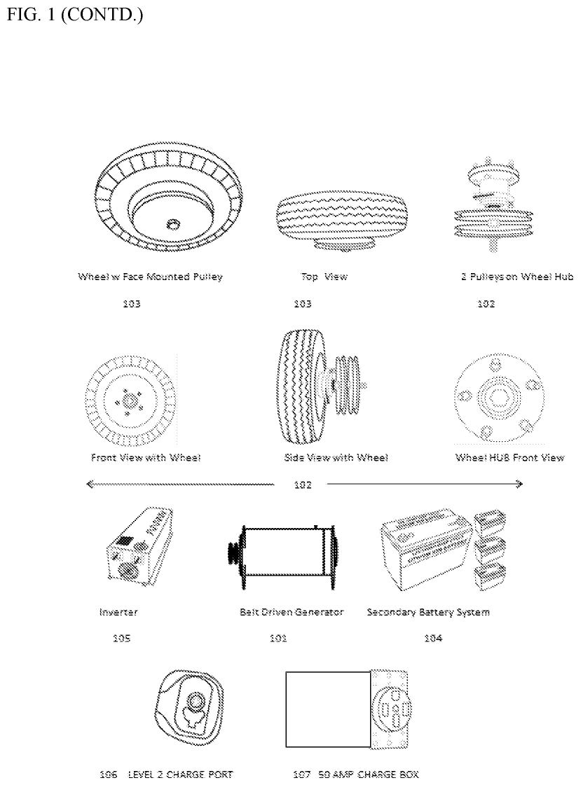

FIG. 1 is a schematic component diagram and black and white line drawing of the Onboard Zero Emission Recharging System, according to the present invention.

Referring to FIG. 1, the Zero Emission Onboard Charging System 100 includes a belt driven generator or generators 101 and a pulley or pulleys 102 attached to a wheel or wheels 103 adapted for installation in an electric vehicle, a secondary battery system 104 of the electric vehicle or underneath the vehicle, an inverter or inverters 105 and a 220V-240V charging box 106 adapted for installation in the electric vehicle.

The belt driven generator 101 may be an 110V or 220V generator which meets required safety requirements for use in electric vehicles, may be any other similar belt driven generators on the market and known to those skilled in the art, and may be up to 240V in terms of power. The belt driven generator 101 provides the charge to the electric vehicle through the inverter 105 and or charging box 106,

The electric outlet charging box 106 (hereinafter, charging box) is a 220V box in FIG. 1, but may also be a 110V, 240V box when a 110V or 240V belt driven generator is used. The charging box 106 is a standard box for connecting electric wires and may provide a 220-240V charge through a 220-240V into an inverter 104 that provides a charge through battery terminals connected to either to backup batteries directly or to charging port 107 adapted for installation in the engine compartment connected to the primary battery system. The charging port 107 sends the charge to the direct charge input 109, which is also adapted for installation in the engine compartment 108 and directs the charge to the electric vehicle engine in order to propel the electric vehicle.

Another 220-240V Level 2 charge cable extends directly into the inverter input from the belt driven generator 105. When activated, i.e., when the electric vehicle is in motion and is fully operable, charge cable provides a charge to the direct charge input of the electric vehicle when the Zero Emission Onboard Charging System 100 is operating. In this manner, the direct charge input may charge the primary or secondary battery system powering the electric vehicle while a user is operating the electric vehicle.

That is, similar to an operation in conventional electric vehicle charging, the charge cable is plugged into the charging box of the electric vehicle, and the secondary battery system charges the primary battery of the parked electric vehicle. This is effectively the equivalent of plugging in the electric vehicle cable at a charging station, as the electric vehicle must be stationary in order to receive the charge from the charging station or secondary battery system. Since, as in the case of the Bolt, many electric vehicles are designed to remain in “park” if the charging chord is connected to the electric vehicle when turned on, since the charging port is connected via the electric vehicle charging cable. Electric vehicles by other manufacturers have a similar precautionary feature when electrically connected to a charging station. In order to deliver the charge while operating the vehicle a backup battery system receives the charge which can in turn be used to charge the electric vehicle while parked or “plugless” relay of the charge from secondary battery to primary battery may be available in future versions of the invention.

However, the present invention provides a Zero Emission Onboard Charging System 100 that negates the requirement of a charging station. In addition, a charge cable is provided as an alternative and is adapted to bypass the charging port and to plug directly into the charge input from the inverter , thereby enabling the electric vehicle to be fully drivable while the onboard zero emission recharging system 100 is being operated.

The Zero Emission Onboard Charging System 100 is shown from the perspective of components of the zero emission onboard recharging system of the electric vehicle, which may vary in terms of physical location in various electric vehicles as opposed to the present invention as may be installed in the aforementioned Bolt. However, the electric vehicle may vary and be supplied by various EV manufacturers, including hatchbacks, pickup trucks, sedans, and other electric vehicle designs in such case as components will be installed and configured accordingly.

The belt driven generator or generators is/are located inside of electric vehicle such that it can be attached to the pulley connected to a wheel, which generally comprises the front or rear compartments of the electric vehicle.

Specifically, the undercarriage constitutes a platform onto which the belt driven generator and wheel with pulleys are mounted onto two cross-members and constructed of steel that is about 5 inches in width, extend under the rear compartment and are fastened to the electric vehicle chassis and the flooring for structural integrity, such as by bolting or another suitable manner. The belt driven generators may be fastened to the flooring by bolting, as well.

Embodiments of the present invention disclosed in the specification and the drawings are only particular examples disclosed in order to easily describe the technical matters of the present invention and assist with comprehension of the present invention, and do not limit the scope of the present invention. Therefore, in addition to the embodiments disclosed herein, the scope of the embodiments of the present invention should be construed to include all modifications or modified forms drawn based on the technical aspects of the embodiments of the present invention.

While the present invention has been described with reference to various embodiments, various changes may be made without departing from the spirit and the scope of the present invention, which is defined, not by the detailed description and embodiments, but by the appended claims and their equivalents.

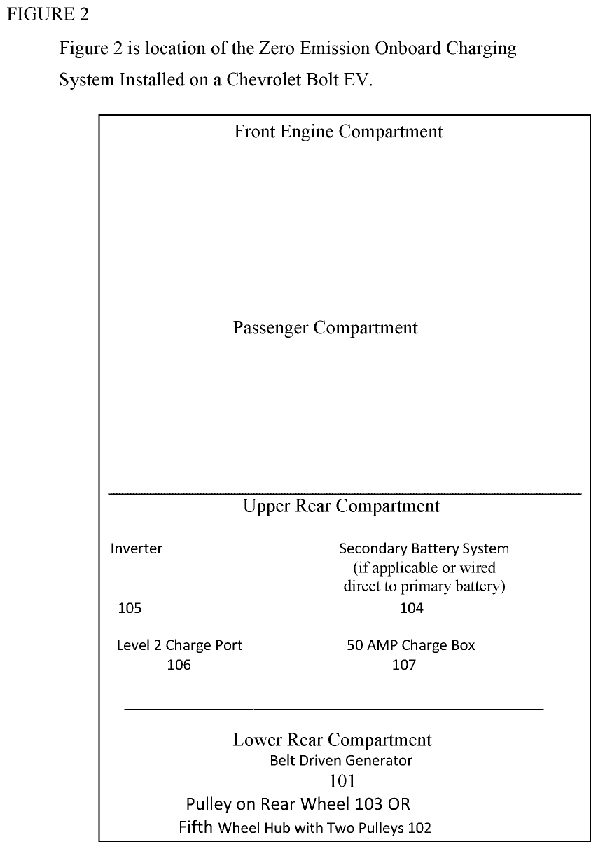

Referring to FIG. 2 drawing is a diagram showing location of the installation of the Zero Emission Onboard Charging System components installed on a Chevrolet Bolt vehicle.

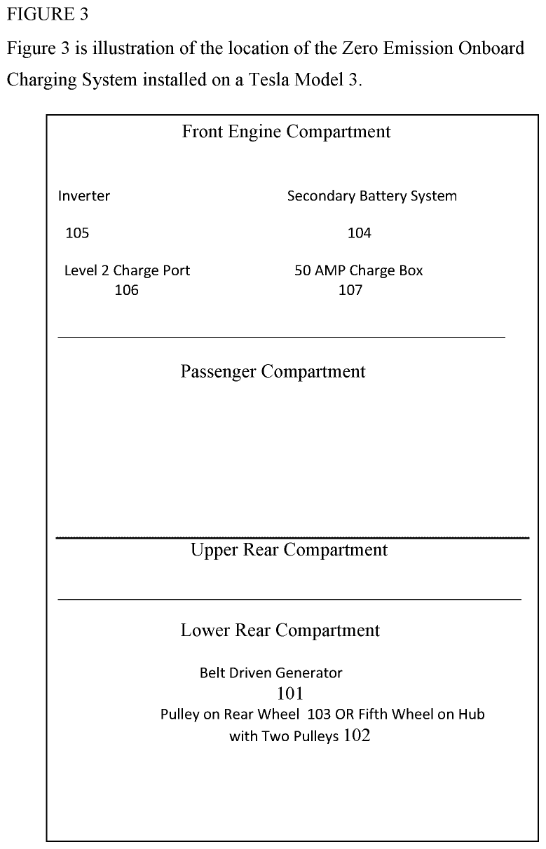

Referring to FIG. 3 drawing is a diagram showing location of the installation of the Zero Emission Onboard Charging System components installed on a Tesla Model 3 vehicle.

What is claimed is:

1. A Zero Emission Onboard Charging System for a vehicle, comprising:
a belt driven generator or generators configured to be installed in the vehicle;
a pulley or pulleys attached to an individual wheel or multiple wheels configured to be attached by belts to the generator or generators wired to an inverter or inverters deliver charges to primary or backup battery system which also has been configured to receive charge from belt driven generator or generators; and a charge input configured to receive the charge from battery system to the inverter charging port and supply the charge to a primary battery and or secondary battery system that powers an engine of the vehicle.

2. The Zero Emission Onboard Charging System of claim 1, wherein the vehicle is an electric vehicle and the engine is an electric vehicle engine, and wherein the charge is 110 volts, 220 volts or 240 volts.

3. The Zero Emission Onboard Charging System of claim 2, wherein the generator is a belt drive generator or generators powered by a pulley or pulleys connected to a wheel or wheels on the electric vehicle connected to inverters connected to a battery system.

4. The Zero Emission Onboard Charging System of claim 3, wherein no fuel is require to operate the vehicle and no emission or pollution is emitted from the electric vehicle.

5. The Zero Emission Onboard Charging System of claim 4, further comprising a proprietary Lithium Ion primary battery rated at 60 Khz and secondary Lithium Ion battery system rated at 60 Khz, the rating of which will vary by the vehicle customized for each Zero Emission Onboard Charging System, electrically connected to inverters and the belt driven generators;

6. The Zero Emission Onboard Charging System of claim 5, a series of charging cables configured to electrically connect to the primary and secondary battery system, charging box to charge the secondary battery system while operating (driving) the vehicle and connect to the charging port for the primary battery and to supply the charge to the charging port while the vehicle is stationery to recharge the primary battery.

7. The Zero Emission Onboard Charging System of claim 6, collectively method of charging a primary and secondary battery system powering an engine in a vehicle, comprising ability to continually charge the vehicle eliminating need for or reliance on charging via plugging into the power grid or public charging stations while leaving the option to do so if desired.
